(19) United States
(12) Patent Application Publication
(10) Pub. No.: US 2018/0234040 A1
(43) Pub. Date: Aug. 16, 2018

(54) MOTOR

(71) Applicant: NIDEC SANKYO CORPORATION, Suwa-gun Nagano (JP)

(72) Inventor: Mitsuo YOKOZAWA, Suwa-gun Nagano (JP)

(21) Appl. No.: 15/739,447

(22) PCT Filed: Jun. 15, 2016
(86) PCT No.: PCT/JP2016/067830

§ 371 Date: Dec. 22, 2017

(30) Foreign Application Priority Data
Jun. 23, 2015 (JP) 2015-125730

(51) Int. Cl. H02P 6/16; H02K 29/08; H02P 25/022

(52) U.S. Cl. CPC H02P 6/16; H02P 25/022; H02K 29/08

(57) ABSTRACT

A motor may include a rotor; a stator; a first Hall element and a second Hall element which face a drive magnet provided in the rotor at different angular positions, a storage section configured to store reference data prepared by associating a rotation position of the rotor with a signal of the first Hall element obtained at the rotation position and a signal of the second Hall element obtained at the rotation position; and a position detection section configured to obtain a rotation position of a detection target by referring to the reference data based on a first signal and a second signal wherein, when the rotor is located at the rotation position of the detection target, a signal of the first Hall element is referred to as the first signal and a signal of the second Hall element is referred to as the second signal.

### CROSS REFERENCE TO RELATED APPLICATIONS

This is the U.S. national stage of application No. PCT/JP2016/067830, filed on Jun. 15, 2016. Priority under 35 U.S.C. § 119(a) and 35 U.S.C. § 365(b) is claimed from Japanese Application No. 2015-125730, filed Jun. 23, 2015; the disclosure of which is incorporated herein by reference.

### FIELD OF THE INVENTION

At least an embodiment of the present invention relates to a motor which is provided with an encoder function for detecting a rotation position.

### BACKGROUND

A motor has been known which is provided with an encoder function for detecting positional information (rotation position) of a rotor in order to control the rotation position of the motor. For example, an optical type encoder is mounted on a motor and positional information is detected based on pulse signals of the optical type encoder. Alternatively, a plurality of Hall elements is mounted on a motor and a rotation position of the rotor is obtained by calculating signals outputted from the Hall elements. This type of motor is disclosed in Patent Literatures 1 and 2.

### PATENT LITERATURE

[PTL 1] Japanese Patent Laid-Open No. Hei 7-337076

[PTL 2] Japanese Patent Laid-Open No. 2013-99023

Patent Literatures 1 and 2 disclose that three Hall elements are disposed at different angular positions and signals outputted from the three Hall elements are compared and calculated to obtain positional information. However, in the structures disclosed in Patent Literatures 1 and 2, three Hall elements are required to be mounted on a motor and thus it is difficult to reduce the size and a cost of the motor. Further, in order to control rotation of a motor with a high degree of accuracy, it is required that positional information (rotation position) is obtained with a high degree of accuracy.

### SUMMARY

In view of the problem described above, at least an embodiment of the present invention provides a motor capable of reducing its size and cost and capable of detecting its rotation position with a high degree of accuracy.

To achieve the above, at least an embodiment of the present invention provides a motor including a rotor and a stator, a first Hall element and a second Hall element which face a drive magnet provided in the rotor at different angular positions, a storage section which stores reference data prepared by associating a rotation position of the rotor with a signal of the first Hall element obtained at the rotation position and a signal of the second Hall element obtained at the rotation position, and a position detection section which obtains a rotation position of a detection target by referring to the reference data based on a first signal and a second signal wherein, when the rotor is located at the rotation position of the detection target, a signal of the first Hall element is referred to as the first signal and a signal of the second Hall element is referred to as the second signal.

According to at least an embodiment of the present invention, signals which vary depending on a rotation position of the rotor can be obtained from two Hall elements. Then, the rotation position of the rotor can be obtained by referring to the reference data having been previously prepared based on these signals. Therefore, without using a magnet for detecting a rotation position or an optical type encoder, a rotation position of the rotor can be detected only by adding two Hall elements to the motor. Accordingly, the size and cost of the motor can be reduced. Further, the rotation position is obtained by using reference data having been previously prepared for each of motors and thus the rotation position can be detected with a simple algorithm and with a high degree of accuracy. Further, rotation of the motor can be controlled with a high degree of accuracy by performing feedback control by using the detected rotation position.

In at least an embodiment of the present invention, it is desirable that the position detection section obtains all combinations of first candidates which are candidates of the rotation position corresponding to the first signal and second candidates which are candidates of the rotation position corresponding to the second signal from the reference data, and the position detection section calculates a difference of the first candidate and the second candidate in each of the obtained combinations and obtains the rotation position of the detection target from the combination that a value of the difference is the smallest. According to this structure, the rotation position can be detected with a simple algorithm and a high degree of accuracy.

Alternatively, it is desirable that the position detection section obtains all combinations of first candidates which are candidates of the rotation position corresponding to the first signal and second candidates which are candidates of the rotation position corresponding to the second signal, the first candidates and the second candidates being adjacent candidates of the rotation position to each other, and the position detection section calculates a difference of the first candidate and the second candidate in each of the obtained combinations and obtains the rotation position of the detection target from the combination that a value of the difference is the smallest. According to this structure, the number of the combinations to be compared can be reduced and thus the processing for detecting the rotation position can be performed in a short time.

In at least an embodiment of the present invention, it is desirable that, in a case that the number of magnetic poles of the drive magnet is four or more, the reference data includes first reference data which are prepared by associating the rotation position of the rotor with the signal of the first Hall element obtained at the rotation position, and second reference data which are prepared by associating the rotation position of the rotor with the signal of the second Hall element obtained at the rotation position, each of the first reference data and the second reference data includes a plurality of peak values and a plurality of bottom values, and a plurality of inclined parts which are located between the peak values and the bottom values adjacent to each other. The position detection section obtains the first candidates one by one from the inclined part including the rotation position of the rotor detected latest and from the two adjacent inclined parts located on both sides by referring to the first reference data, and the position detection section obtains the second candidates one by one from the inclined part including the rotation position of the rotor detected latest and from the two adjacent inclined parts located on both sides by referring to the second reference data, and the position detection section obtains the rotation position of the detection target from the combination that a difference between the first candidate and the second candidate is the smallest among the combinations of the three first candidates having been obtained and the three second candidates having been obtained. According to this structure, the number of the combinations to be compared can be reduced to nine (9). Therefore, the processing for detecting the rotation position can be performed in a short time.

Alternatively, it is desirable that the position detection section obtains the combinations where one or both of the first candidate and the second candidate are located in the inclined parts including the rotation position of the rotor detected latest among the combinations of the three first candidates and the three second candidates, and the position detection section obtains the rotation position of the detection target from the combination that a difference between the first candidate and the second candidate is the smallest among the combinations having been obtained. According to this structure, the number of the combinations to be compared can be reduced to five (5). Therefore, the processing for detecting the rotation position can be performed in a short time.

In at least an embodiment of the present invention, it is desirable that the position detection section sets the rotation position obtained from the combination that the difference between the first candidate and the second candidate is the smallest to a home position of the rotation position of the rotor. According to this structure, the rotation position can be detected based on an angular difference from the home position and thus the motor can be provided with a function of an incremental encoder.

Further, in this case, it is desirable that the storage section stores the rotation position obtained from the combination that the difference between the first candidate and the second candidate is the second smallest as a correction candidate position for correcting the home position. According to this structure, when the position set to the home position is not accurate, the home position can be corrected simply and immediately by using the correction candidate.

In at least an embodiment of the present invention, it is desirable that the position detection section obtains the rotation position of the rotor by referring to reference data based on normalized data which are prepared by normalizing a signal of the first Hall element and a signal of the second Hall element. According to this structure, an influence of sensitivity variations and mounting position errors of the two Hall elements can be reduced.

Further, in this case, it is desirable that the position detection section updates at a previously set timing a coefficient which is used in a normalizing processing in which the signal of the first Hall element and the signal of the second Hall element are normalized. According to this structure, an influence of a signal variation of the Hall element due to variation of ambient temperature, a supplied voltage or the like can be reduced. Therefore, the rotation position can be detected with a high degree of accuracy.

In at least an embodiment of the present invention, it is desirable that the reference data includes a plurality of peak values and a plurality of bottom values, and the position detection section obtains a current position of the rotor based on a magnitude relationship and an arrangement order of the plurality of the peak values and the plurality of the bottom values. When the magnitude relationship of the peak values and the bottom values and the arrangement order are discriminated and the rotation position is detected based on its information, the absolute position and a rotating direction can be detected

According to at least an embodiment of the present invention, it is desirable that a magnetized pattern of the drive magnet is formed in a sine wave shape. When this type of drive magnet is used, signals of the first and the second Hall elements due to rotation of the rotor are gradually varied. Therefore, reference data with a high resolution of a rotation position can be obtained. Accordingly, detection accuracy when a rotation position is detected by using the reference data is enhanced.

According to at least an embodiment of the present invention, without using a magnet for detecting a rotation position or an optical type encoder, a rotation position of the rotor can be detected only by adding two Hall elements to the motor. Therefore, the size and cost of the motor can be reduced. Further, the rotation position is obtained by using reference data having been previously prepared for each of motors and thus the rotation position can be detected with a simple algorithm and a high degree of accuracy.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a perspective outward appearance view showing a motor in at least an embodiment of the present invention.

FIGS. 2A and 2B are explanatory views showing a structure of a motor in at least an embodiment of the present invention.

FIG. 3 is a schematic block diagram showing a control system for a motor in at least an embodiment of the present invention.

FIG. 4 is an explanatory view showing normalized data which are obtained by normalizing signals of a first Hall element and a second Hall element.

FIGS. 5A and 5B are explanatory views showing reference data used in detection processing of a rotation position.

FIG. 6 is an explanatory view showing a detection method of a rotation position in which reference data are used.

FIG. 7 is an explanatory view showing a detection method of a rotation position in a modified embodiment.

### DETAILED DESCRIPTION

At least an embodiment of a motor to which the present invention is applied will be described below with reference to the accompanying drawings.

### (Structure of Motor)

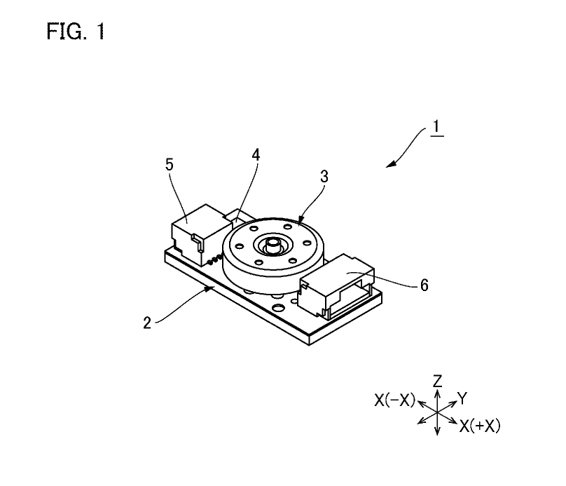

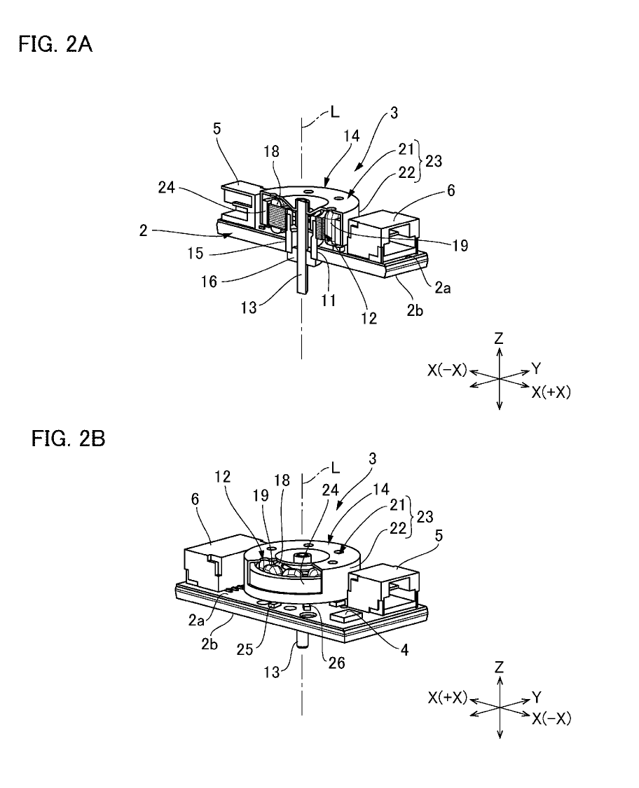

FIG. 1 is a perspective outward appearance view showing a motor to which at least an embodiment of the present invention is applied. Further, FIGS. 2A and 2B are explanatory views showing a structure of a motor to which at least an embodiment of the present invention is applied. FIG. 2A is its cross-sectional view and FIG. 2B is a perspective view showing the motor in which a rotor is partly cut out. The “X”, “Y” and “Z” directions shown in FIGS. 1, 2A and 2B are directions perpendicular to each other. A motor 1 is a motor unit which includes a rectangular circuit board 2, a motor main body 3 attached to a center portion of the circuit board 2, a motor control unit 4 mounted on the circuit board 2, and a first connector 5 and a second connector 6 which are attached on both sides of the motor main body 3 in a longitudinal direction (“X” direction) of the circuit board 2. The first connector 5 is fixed on a first direction “−X” side with respect to the motor main body 3 in the longitudinal direction “X” and the second connector 6 is fixed on a second direction “+X” side with respect to the motor main body 3 in the longitudinal direction “X”. In this embodiment, in FIG. 2A, the motor 1 is viewed from the second direction “+X” side and, in FIG. 2B, the motor 1 is viewed from the first direction “−X” side. In FIG. 2B, a rotor main body structuring the motor main body 3 is partly cut out.

The circuit board 2 is structured so that a wiring layer and an insulating layer are formed on one side (front face) of a base member made of aluminum in a multilayered manner by a build-up method. A fixing hole 11 (fixing part) for fixing the motor main body 3 is provided in a center portion of the circuit board 2 as shown in FIG. 2A.

The circuit board 2 is provided with lands which are connected with wiring patterns of the wiring layers. Terminals of the motor control unit 4 are connected with the circuit board 2 through the lands. Further, the circuit board 2 is structured so that a plurality of wiring layers is conducted by via-hole-filling plating formed at positions overlapped with the lands. In the circuit board 2, heat generated by the motor control unit 4 is transmitted from the terminals of the motor control unit 4 to the insulating layer whose thermal conductivity is high through the lands and the via-hole-filling plating of the circuit board 2 and then transmitted to the base member made of aluminum. Therefore, the heat of the motor control unit 4 can be efficiently radiated through the base member.

For example, a wafer level chip size package (WLCSP) is used as the motor control unit 4. The motor control unit 4 includes a driver circuit for driving the motor main body 3, a controller circuit for controlling drive of the motor main body 3, an amplifier circuit and the like. In other words, the motor 1 in this embodiment is structured by integrating the motor main body 3 with a control circuit board for the motor main body 3.

The motor main body 3 is a three-phase permanent magnet synchronous motor (PMSM). The motor main body 3 includes a stator 12, a rotor 14 having an output shaft 13, a sleeve 15 which supports the stator 12 in a state that the sleeve 15 is penetrated through the fixing hole 11, and a bearing 16 which is fixed to the sleeve 15. An axial line “L” of the motor main body 3 (rotation center line of the output shaft 13) is extended in a direction perpendicular to the circuit board 2 (“Z” direction). The bearing 16 is fixed to an end portion of the sleeve 15 on a rear face 2b side of the circuit board 2. The bearing 16 rotatably supports the output shaft 13 (rotor 14) around the axial line “L”.

The stator 12 includes a ring-shaped stator core 18 provided with a plurality of salient poles protruded in a radial direction, and drive coils 19 which are wound around the respective salient poles. The stator core 18 is disposed on the front face 2a side of the circuit board 2. A front face side protruded portion of the sleeve 15 which is protruded to the front face 2a side of the circuit board 2 is inserted into a center hole of the stator core 18. In this manner, the stator core 18 is fixed to the circuit board 2 through the sleeve 15.

The rotor 14 includes a rotor case 23, which is provided with a circular bottom plate part 21 and a ring-shaped plate part 22 extended from an outer peripheral edge portion of the bottom plate part 21 toward the circuit board 2 side, and a drive magnet 24 which is fixed to an inner peripheral face of the ring-shaped plate part 22. The output shaft 13 is fixed to the center of the bottom plate part 21 and is extended on an inner side of the ring-shaped plate part 22 so as to be coaxial with the rotor case 23. The output shaft 13 is protruded from a circular opening part of the rotor case 23 (from an opening on the circuit board 2 side).

The rotor 14 is assembled in a state that the stator core 18 is covered with the rotor case 23 from the front face 2a side of the circuit board 2, the output shaft 13 is inserted into the sleeve 15, and a tip end portion of the output shaft 13 is protruded from the sleeve 15 to the rear face 2b side of the circuit board 2. As a result, the salient poles of the stator core 18 and the drive magnet 24 face each other in the radial direction.

The drive magnet 24 faces a first Hall element 25 and a second Hall element 26 which are mounted on the front face 2a of the circuit board 2 with a predetermined space therebetween. The first Hall element 25 and the second Hall element 26 are disposed at separated positions from each other in a circumferential direction when viewed with the axial line “L” of the rotor 14 as a center. The stator 12 includes three-phase drive coils 19 and the first Hall element 25 and the second Hall element 26 are disposed in spaces between the adjacent drive coils 19.

The drive magnet 24 is magnetized to six poles with a magnetized pattern in a sine wave shape. When the rotor 14 is rotated, periodic variation of a magnetic field is generated at positions of the first Hall element 25 and the second Hall element 26 according to rotation of the drive magnet 24. The first Hall element 25 and the second Hall element 26 output signals “Ha” and “Hb” which are varied periodically based on variation of the magnetic field according to rotation of the rotor 14. The first Hall element 25 and the second Hall element 26 are disposed so that the signals “Ha” and “Hb” output signals whose phases are shifted by 120 degrees in an electrical angle. In accordance with an embodiment of the present invention, the first Hall element 25 and the second Hall element 26 may be disposed so that phases of the signals “Ha” and “Hb” are shifted by a value other than 120 degrees.

### (Motor Control Unit)

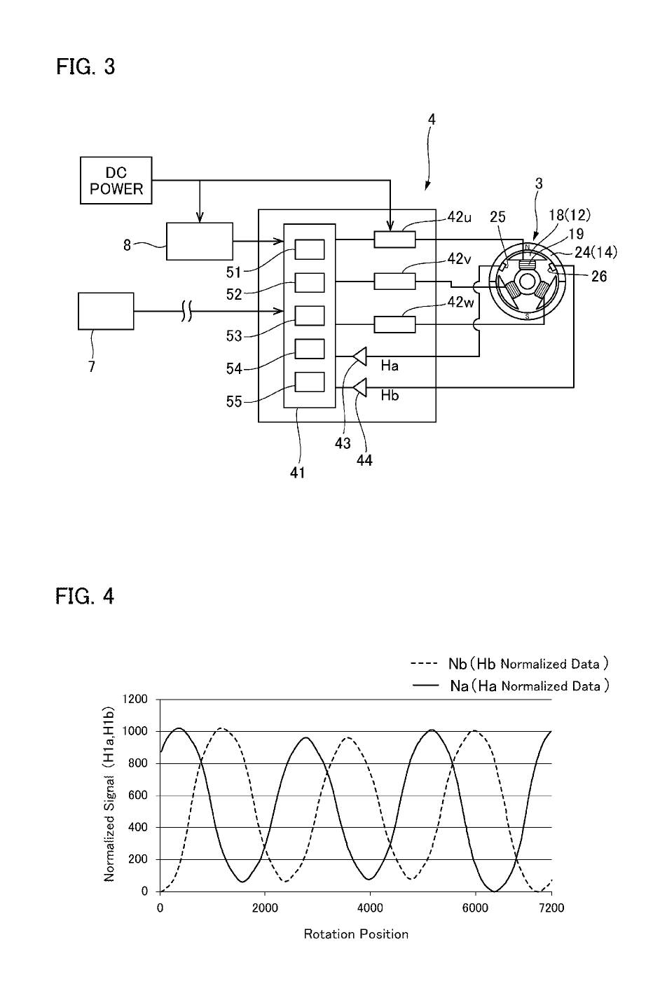

FIG. 3 is a schematic block diagram showing a control system of the motor 1. The motor control unit 4 includes a control unit 41 in which an MPU, a DSP and the like are incorporated. A control signal is inputted to the control unit 41 from a host device 7 and electric power is supplied to the control unit 41 through a power supply circuit 8. Driver circuits 42u, 42v and 42w which control power-feeding to coils 19 of “U”-phase, “V”-phase and “W”-phase are connected with an output side of the control unit 41. As described above, the motor main body 3 includes the first Hall element 25 and the second Hall element 26 which are disposed at different angular positions. Signals “Ha” and “Hb” outputted from the first Hall element 25 and the second Hall element 26 are amplified by differential amplifier circuits 43 and 44 and then inputted into the control unit 41. In accordance with an embodiment of the present invention, the differential amplifier circuits 43 and 44 may be incorporated in the first Hall element 25 side and the second Hall element 26 side.

The control unit 41 includes a normalization processing section 51 in which processing is performed so that the signals “Ha” and “Hb” of the first Hall element 25 and the second Hall element 26 are divided by a coefficient corresponding to the maximum amplitude to convert into normalized data, a storage section 52 in which reference data and the like prepared in advance are stored, a position detection section 53 in which a rotation position of the rotor 14 is detected by using the reference data stored in the storage part 52, a calibration executing section 54 in which calibration for preparing the reference data is executed, a feedback control section 55 in which the rotation position detected by the position detection section 53 and a target position are compared with each other and control signals (PWM signals) for making the rotation position coincide with the target position are supplied to the driver circuits 42u, 42v and 42w, and the like.

### (Normalization Processing)

FIG. 4 is an explanatory view showing normalized data which are obtained by normalizing the signal “Ha” of the first Hall element 25 and the signal “Hb” of the second Hall element 26. FIG. 4 shows normalized data in a range where the rotor 14 rotates one time (360 degrees in terms of mechanical angle). A horizontal axis in FIG. 4 shows a rotation position of the rotor 14 and one rotation of the rotor corresponds to the number of pulses of 7200. Further, a vertical axis in FIG. 4 shows a normalized value of a signal of a Hall element and the maximum amplitudes of the signals “Ha” and “Hb” are converted into 1024. The solid line in FIG. 4 shows a first normalized data “Na” in which a normalized signal “H1a” obtained by normalizing the signal “Ha” of the first Hall element 25 is created over a range where the rotor 14 rotates one time. Further, the broken line in FIG. 4 shows a second normalized data “Nb” in which a normalized signal “H1b” obtained by normalizing the signal “Hb” of the second Hall element 26 is created over a range where the rotor 14 rotates one time.

The normalization processing section 51 includes a filter circuit for performing noise removal processing on the signals “Ha” and “Hb” inputted into the control unit 41. Normalization processing is performed on the signals “Ha” and “Hb” after noise is removed, and normalized signals “H1a” and “H1b” are obtained and then the first normalized data “Na” and the second normalized data “Nb” are created. Further, the normalization processing section 51 performs processing in which the maximum amplitudes of the signals “Ha” and “Hb” are converted to 1024 and, in this case, a coefficient used in the conversion processing (for example, values obtained by respectively dividing the maximum amplitude values of the signals “Ha” and “Hb” by 1024) is updated at a predetermined timing. For example, the coefficient is updated in every fixed time period.

### (Reference Data)

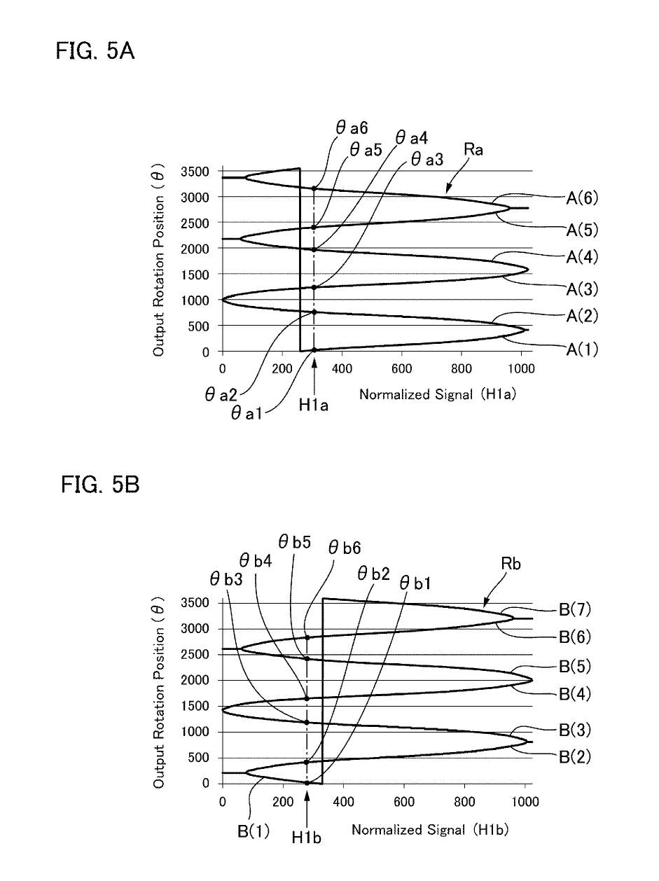

FIGS. 5A and 5B are explanatory views showing reference data used in detection processing of a rotation position. FIG. 5A is a graph showing a first reference data and FIG. 5B is a graph showing a second reference data. The calibration execution section 54 executes calibration after the motor 1 is manufactured, or at various timings, for example, before shipment or at the time of repair or maintenance. In the calibration, while detecting a rotation position of the rotor 14 by using a reference encoder, the signal “Ha” of the first Hall element 25 and the signal “Hb” of the second Hall element 26 are detected to prepare a first reference data “Ra” (see FIG. 5A) and a second reference data “Rb” (see FIG. 5B), which are stored in the storage section 52.

When the calibration is to be executed, a reference encoder is mounted on the motor 1 and the motor 1 and the reference encoder are connected each other so that a signal of the reference encoder is inputted into the motor control unit 4. In this state, first, while detecting a rotation position of the rotor 14 by using the reference encoder through one rotation of the rotor 14, the calibration execution section 54 acquires a signal “Ha” of the first Hall element 25 to normalize the signal “Ha” and, in addition, acquires a signal “Hb” of the second Hall element 26 to normalize the signal “Hb”. As a result, the first normalized data “Na” and the second normalized data “Nb” are obtained in a case that the horizontal axis in FIG. 4 is a reference rotation position.

Next, the calibration execution section 54 converts the first normalized data “Na” into the first reference data “Ra” shown in FIG. 5A. Further, the calibration execution section 54 converts the second normalized data “Nb” into the second reference data “Rb” shown in FIG. 5B. The first reference data “Ra” are prepared by associating each value of the normalized signal “H1a” of 1024 levels which are included in the first normalized data “Na” for one rotation of the rotor with a rotation position of the rotor 14 (output rotation position). Further, the second reference data “Rb” are prepared by associating each value of the normalized signal “H1b” of 1024 levels which are included in the second normalized data “Nb” for one rotation of the rotor with a rotation position of the rotor 14 (output rotation position).

In this embodiment, the drive magnet 24 is magnetized to six poles. Therefore, each of signal variations of the first Hall element 25 and the second Hall element 26 during one rotation of the rotor 14 becomes a curved line in which three peak values and three bottom values are alternately appeared as shown in FIG. 4. As shown in FIG. 5A, in the first reference data “Ra”, inclined parts are respectively located between peak values and bottom values adjacent to each other, and the first reference data “Ra” are provided with six inclined parts A(1), A(2), A(3), A(4), A(5) and A(6). Similarly, in the second reference data “Rb” shown in FIG. 5B, inclined parts are respectively located between peak values and bottom values adjacent to each other, and the second reference data “Rb” are provided with six inclined parts B(1), B(2), B(3), B(4), B(5) and B(6).

As shown in FIG. 5A, one value (one normalized signal “H1a”) of the first reference data “Ra” on the horizontal axis is associated with six output rotation positions θa1, θa2, θa3, θa4, θa5 and θa6. The output rotation positions θa1 through θa6 are respectively existed one by one on the six inclined parts A(1) through A(6). In other words, the output rotation position θal is located on the inclined part A(1), the output rotation position θa2 is located on the inclined part A(2), the output rotation position θa3 is located on the inclined part A(3), the output rotation position θa4 is located on the inclined part A(4), the output rotation position θa5 is located on the inclined part A(5), and the output rotation position θa6 is located on the inclined part A(6).

Further, as shown in FIG. 5B, one value (one normalized signal “H1b”) of the second reference data “Rb” on the horizontal axis is associated with six output rotation positions θb1, θb2, θb3, θb4, θb5 and θb6. The output rotation positions θb1 through θb6 are respectively existed one by one on the six inclined parts B(1) through B(6). In other words, the output rotation position θb1 is located on the inclined part B(1), the output rotation position θb2 is located on the inclined part B(2), the output rotation position θb3 is located on the inclined part B(3), the output rotation position θb4 is located on the inclined part B(4), the output rotation position θb5 is located on the inclined part B(5), and the output rotation position θb6 is located on the inclined part B(6).

The first reference data “Ra” and the second reference data “Rb” stored in the storage section 52 are a matrix table in which six values of the output rotation position “θ” are associated with each of the 1024 levels of the normalized signals “H1a” and “H1b”. The position detection section 53 performs linear complementation if necessary and obtains candidates of a rotation position corresponding to the signal “Ha” of the first Hall element 25 and the signal “Hb” of the second Hall element 26 based on the matrix table. Then, the rotation position is detected by selecting an appropriate candidate position among the obtained candidate positions.

### (Detection Method of Rotation Position)

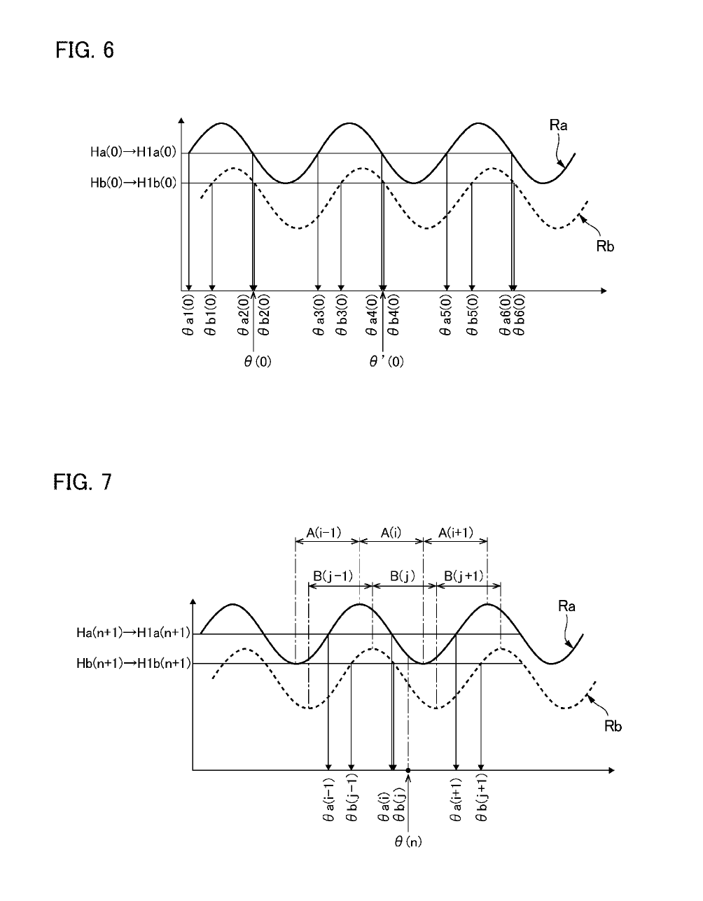

FIG. 6 is an explanatory view schematically showing a detection method of a rotation position in which the reference data are used. In this embodiment, a signal of the first Hall element 25 obtained when the rotor 14 is located at a rotation position θ(0) of a detection target is referred to as a first signal “Ha(0), and a signal of the second Hall element 26 obtained when the rotor 14 is located at the rotation position θ(0) of the detection target is referred to as a second signal “Hb(0). When the rotation position θ(0) of the detection target is to be obtained in the position detection section 53, the position detection section 53 acquires the first signal “Ha” and the second signal “Hb” and obtains the rotation position θ(0) of the detection target by referring to the first reference data “Ra” and the second reference data “Rb” based on the first signal “Ha” and the second signal “Hb”.

Specifically, the position detection section 53 obtains the normalized signal “H1a(0)” of the first signal “Ha” and the normalized signal “H1b(0)” of the second signal “Hb”. After that, all the candidates of the rotation position θ(0) corresponding to the normalized signal “H1a(0)” are extracted by using the first reference data “Ra”. As a result, six first candidates θa1(0), θa2(0), θa3(0), θa4(0), θa5(0) and θa6(0) are extracted. Similarly, all the candidates of the rotation position θ(0) corresponding to the normalized signal “H1b(0)” are extracted by using the second reference data “Rb”. As a result, six second candidates θb1(0), θb2(0), θb3(0), θb4(0), θb5(0) and θb6(0) are extracted.

FIG. 6 shows a state that all the first candidates θa1(0) through θa6(0) corresponding to the first signal “Ha(0)” and all the second candidates θb1(0) through θb6(0) corresponding to the second signal “Hb(0) are distributed over the horizontal axis. The position detection section 53 obtains all of combinations of the first candidates θa1(0) through θa6(0) and each of the second candidates θb1(0) through θb6(0) (in round robin). Then, a difference between the two candidate positions (the first candidate and the second candidate) is calculated with respect to each of the obtained combinations. For example, a difference between the first candidate θa1(0) and the second candidate θb1(0) is calculated with respect to the combination of the first candidate θa1(0) and the second candidate θb1(0). Similarly, all the differences are also calculated with respect to the remaining combinations and magnitudes of all the differences are compared. Then, the rotation position θ(0) of the detection target is obtained from the combination that a value of the difference is the smallest. In this embodiment, an average value of the two candidate positions (the first candidate and the second candidate) structuring the combination that the value of the difference is the smallest is determined as the rotation position θ(0) of the detection target. For example, in a case of an example shown in FIG. 6, the combination of the first candidate θa2(0) and the second candidate θb2(0) is that they are located at the closest positions on the horizontal axis, and the difference between the first candidate θa2(0) and the second candidate θb2(0) is the smallest. Therefore, the position detection section 53 determines that the average value of the first candidate θa2(0) and the second candidate θb2(0) is the rotation position θ(0) of the detection target.

### (Setting of Initial Home Position)

The position detection section 53 performs processing for detecting a rotation position (initial rotation position) of the rotor 14 by using the above-mentioned detection method as an initialization processing before drive of the motor 1 is started. Processing for detecting an initial rotation position is, for example, performed when the motor 1 is changed from a state that the motor 1 does not monitor signals of the first Hall element 25 and the second Hall element 26 to a state that the motor 1 monitors the signals of the first Hall element 25 and the second Hall element 26. For example, the processing for detecting the initial rotation position is performed, for example, when power is switched on, when the motor 1 is re-started from a rest state, or the like.

The position detection section 53 sets the initial rotation position having been detected to a home position of a rotation position of the rotor 14. Further, the position detection section 53 stores an average value of the combination that a value of the difference is the second-smallest detected in the processing for detecting the initial rotation position to the storage section 52 as a candidate data for correcting the home position (correction candidate position). For example, in the example in FIG. 6, the difference of the combination of the first candidate θa4(0) and the second candidate θb4(0) is the second smallest. Therefore, the average value θ′(0) of the first candidate θa4(0) and the second candidate θb4(0) is stored in the storage section 52 as a correction candidate position.

The first reference data “Ra” and the second reference data “Rb” respectively have a plurality of peak values and a plurality of bottom values and thus a plurality of combinations of candidate positions that a value of the difference is small is existed. For example, in the example in FIG. 6, the value of the difference is the smallest in the combination of the first candidate θa2(0) and the second candidate θb2(0). However, a value of the difference in the combination of the first candidate θa4(0) and the second candidate θb4(0) is small, and a value of the difference in the combination of the first candidate θa6(0) and the second candidate θb6(0) is also small. Therefore, when output variations of the first Hall element 25 and the second Hall element 26, various detection errors or the like are generated, a situation may be occurred that a difference of the candidate position different from the correct rotation position becomes the smallest. In this case, the correct initial rotation position cannot be detected. Therefore, the home position may be set at a displaced position. In this embodiment, after driving of the motor 1 is started, in a case that the initial rotation position which is firstly set as the home position (for example, θ(0) in FIG. 6) is recognized that it is not the correct rotation position, the control unit 41 performs processing that a correction candidate position which has been stored in the storage section 52 (for example, θ′(0) in FIG. 6) is read out and the home position is replaced with the correction candidate position.

### (Operations and Effects)

As described above, in the motor 1 in this embodiment, the signals “Ha” and “Hb” varied depending on a rotation position of the rotor 14 can be obtained from the first Hall element 25 and the second Hall element 26. Further, the rotation position can be obtained by referring to the first reference data “Ra” and the second reference data “Rb” with the use of the signals “Ha” and “Hb”. Therefore, the rotation position of the rotor 14 can be detected by adding two Hall elements to the motor main body 3 without using a magnet for detecting a rotation position or an optical type encoder. Accordingly, it is advantageous to reduce the size and cost of the motor main body 3. Further, the rotation position is determined by using the first reference data “Ra” and the second reference data “Rb” which are previously prepared for every motor 1 through calibration and thus the rotation position can be detected with a high degree of accuracy by a simple algorithm. Further, the rotation of the motor 1 can be controlled with a high degree of accuracy by performing feedback control with the use of detected rotation positions.

The position detection section 53 in this embodiment obtains all of the combinations of the first candidates θa1(0) through θa6(0), which are candidates of the rotation position corresponding to the first signal “Ha(0)”, and the second candidates θb1(0) through θb6(0), which are candidates of the rotation position corresponding to the second signal “Hb(0)”, from the first reference data “Ra” and the second reference data “Rb”. Then, a difference of the two candidate positions is calculated with respect to all obtained combinations and an average value of the two candidate positions structuring the combination that a value of the difference is the smallest is determined as the rotation position θ(0) of the detection target. Therefore, the rotation position can be detected with a high degree of accuracy by a simple algorithm.

In this embodiment, a rotation position detected by the initialization processing of the motor 1 is set as a home position. Therefore, after that, a rotation position can be detected based on an angular difference from the home position and thus the motor 1 can be provided with a function of an incremental encoder. Therefore, incremental control can be performed. In this embodiment, the drive magnet 24 magnetized to six poles is used. However, the number of the poles is not limited to six. For example, when a drive magnet magnetized to two poles is used, an electrical angle and a mechanical angle are coincided with each other and thus the motor 1 can be provided with a function of an absolute encoder.

In this embodiment, in a case that a rotation position is detected in the initialization processing of the motor 1, a combination that a value of a difference of two candidate positions is the second smallest is also obtained in addition to a combination that a value of a difference of two candidate positions is the smallest, and an average value of the two candidate positions structuring the combination is stored as a correction candidate position for correcting the home position. Therefore, when the position set to the home position is not accurate, the home position can be simply and immediately corrected by using the correction candidate position.

In this embodiment, a rotation position of the rotor 14 is obtained by referring to the first reference data “Ra” and the second reference data “Rb” based on the normalized signals “H1a” and “H1b” which are obtained by normalizing the signal “Ha” of the first Hall element 25 and the signal “Hb” of the second Hall element 26. Therefore, an influence of sensitivity variations and mounting position errors of the two Hall elements can be reduced.

In this embodiment, the coefficient is updated which is used in the processing normalizing the signal “Ha” of the first Hall element 25 and the signal “Hb” of the second Hall element 26 at a previously set timing. Therefore, an influence of a signal variation of the Hall element due to variation of ambient temperature, a supplied voltage or the like can be reduced. Accordingly, the rotation position can be detected with a high degree of accuracy.

In this embodiment, the magnetized pattern of the drive magnet 24 is formed in a sine wave shape and thus variations of the signals of the first Hall element 25 and the second Hall element 26 due to rotation of the rotor 14 are gradual. Therefore, reference data whose resolution of a rotation position is high can be obtained and thus detection accuracy when a rotation position is to be detected is enhanced by using the reference data. In this embodiment, even when the drive magnet 24 is magnetized in a pattern other than a sine wave shape, the rotation position of the motor 1 can be detected.

### Modified Embodiments

In the embodiment described above, all the candidates of a rotation position corresponding to the first signal “Ha(0)” and the second signal “Hb(0)” are obtained from the first reference data “Ra” and the second reference data “Rb”, and then, combinations of the two candidate positions (first candidate and second candidate) are prepared in round robin and then, all of differences between the two candidate positions are calculated and the combination that the value of the difference is the smallest is found out. However, the number of the combinations of the two candidate positions (first candidate and second candidate) may be reduced.

For example, in a case that, as shown in FIG. 6, the six first candidates and the six second candidates respectively exist, the number of all the combinations in round robin becomes 36. On the other hand, when the combinations of the two candidate positions (first candidate and second candidate) are limited to combinations of the first candidates and the second candidates adjacent to each other, the number of the combinations can be reduced to 9 (nine) as described below. Therefore, the rotation position can be detected in a short time.

Further, in the embodiment described above, one candidate (first candidate) of a rotation position corresponding to the first signal “Ha(0)” is obtained from each of the six inclined parts A(1) through A(6) of the first reference data “Ra”, and one candidate (second candidate) of the rotation position corresponding to the second signal “Hb(0)” is obtained from each of the six inclined parts B(1) through B(6) of the second reference data “Rb”. Therefore, the six first candidates and the six second candidates exist respectively. However, the number of the first candidates and the second candidates may be limited to a further small number.

FIG. 7 is an explanatory view showing a detection method of a rotation position in a modified embodiment. For example, in a case that a rotation position is repeatedly detected and, when the rotation position detected latest is θ(n), the first candidate and the second candidate can be extracted by respectively limiting three candidates based on the rotation position θ(n) detected latest. Specifically, among the six inclined parts A(1) through A(6) of the first reference data “Ra”, three first candidates θa(i−1), θa(i), and θa(i+1) are obtained by limiting a range of the inclined part A(i) including the rotation position θ(n) detected latest, the inclined parts A(i−1) and A(i+1) located on both sides of the inclined part A(i). Further, among the six inclined parts B(1) through B(6) of the second reference data “Rb”, three second candidates θb(j−1), θb(j), and θb(j+1) are obtained by limiting a range of the inclined part B(j) including the rotation position θ(n) detected latest, the inclined parts B(j−1) and B(j+1) located on both sides of the inclined part B(j). As described above, when candidate positions are obtained by limiting three successive inclined parts A(i−1) through A(i+1) and three successive inclined parts B(j−1) through B(j+1) with the inclined part A(i) and the inclined part B(j) including the rotation position θ(n) detected latest as centers, only the three first candidates and only the three second candidates are obtained. As a result, the number of combinations of the first candidate and the second candidate is 9 (nine) even when prepared in round robin. Therefore, the rotation position can be detected in a short time. Further, according to this method, positions close to the rotation position θ(n) detected latest are set as candidate positions and thus detection accuracy of the rotation position may not be lowered.

Alternatively, as described above, in a case that candidate positions are obtained by limiting three inclined parts A(i−1) through A(i+1) and three inclined parts B(j−1) through B(j+1) with the inclined part A(i) and the inclined part B(j) including the rotation position θ(n) detected latest as centers, combinations may be limited so that either the first candidate or the second candidate is a candidate position existed on the inclined part A(i) and the inclined part B(j) including the rotation position θ(n) detected latest. Specifically, combinations are limited to five combinations, i.e., the first candidate θa(i) and the second candidate θb(j), the first candidate θa(i) and the second candidate θb(j−1), the first candidate θa(i) and the second candidate θb(j+1), the first candidate θa(i−1) and the second candidate θb(j), and the first candidate θa(i+1) and the second candidate θb(j). In this case, the number of the combinations is further reduced and thus the rotation position can be detected in a short time.

Further, the first reference data “Ra” and the second reference data “Rb” in the embodiment described above respectively have three peak values and three bottom values. However, these values do not become the same as each other. In this case, when considered that three peak values and three bottom values do not completely become the same as each other, and that a magnitude relationship of these values is a characteristic peculiar to the motor, it can be determined whether a rotation position is existed between which peak value and which bottom value by distinguishing a magnitude relationship of the peak values and the bottom values and its arrangement order. Therefore, when data of a magnitude relationship of the three peak values and three bottom values and the arrangement order are previously prepared and stored in the storage section 52, the absolute position and a rotating direction can be detected.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A motor comprising:
a rotor;
a stator;
a first Hall element and a second Hall element which face a drive magnet provided in the rotor at different angular positions;
a storage section configured to store reference data prepared by associating a rotation position of the rotor with a signal of the first Hall element obtained at the rotation position and a signal of the second Hall element obtained at the rotation position; and
a position detection section configured to obtain a rotation position of a detection target by referring to the reference data based on a first signal and a second signal wherein, when the rotor is located at the rotation position of the detection target, a signal of the first Hall element is referred to as the first signal and a signal of the second Hall element is referred to as the second signal.

2. The motor according to claim 1, wherein
the position detection section is configured to obtain all combinations of first candidates which are candidates of the rotation position corresponding to the first signal and second candidates which are candidates of the rotation position corresponding to the second signal from the reference data, and
the position detection section is configured to calculate a difference of the first candidate and the second candidate in each of the obtained combinations and obtains the rotation position of the detection target from the combination that a value of the difference is the smallest.

3. The motor according to claim 2, wherein
the position detection section is configured to obtain all combinations of the first candidates and the second candidates being adjacent candidates of the rotation position to each other, and

4. The motor according to claim 2, wherein
a number of magnetic poles of the drive magnet is four or more,
the reference data comprises:
first reference data which are prepared by associating the rotation position of the rotor with the signal of the first Hall element obtained at the rotation position; and
second reference data which are prepared by associating the rotation position of the rotor with the signal of the second Hall element obtained at the rotation position,
each of the first reference data and the second reference data comprises:
a plurality of peak values and a plurality of bottom values; and
a plurality of inclined parts which are located between the peak values and the bottom values adjacent to each other,
the position detection section is configured to obtain the first candidates one by one from the inclined part including the rotation position of the rotor detected latest and from the two adjacent inclined parts located on both sides by referring to the first reference data,
the position detection section is configured to obtain the second candidates one by one from the inclined part including the rotation position of the rotor detected latest and from the two adjacent inclined parts located on both sides by referring to the second reference data, and
the position detection section obtains the rotation position of the detection target from the combination that a difference between the first candidate and the second candidate is the smallest among the combinations of the three first candidates having been obtained and the three second candidates having been obtained.

5. The motor according to claim 4, wherein
the position detection section is configured to obtain the combinations where one or both of the first candidate and the second candidate are located in the inclined parts including the rotation position of the rotor detected latest among the combinations of the three first candidates and the three second candidates,

6. The motor according to claim 2, wherein the position detection section is configured to set the rotation position obtained from the combination that the difference between the first candidate and the second candidate is the smallest to a home position of the rotation position of the rotor.

7. The motor according to claim 6, wherein the storage section is configured to store the rotation position obtained from the combination that the difference between the first candidate and the second candidate is the second smallest as a correction candidate position for correcting the home position.

8. The motor according to claim 1, wherein the position detection section is configured to obtain the rotation position of the rotor by referring to the reference data based on normalized data which are prepared by normalizing a signal of the first Hall element and a signal of the second Hall element.

9. The motor according to claim 8, wherein the position detection section is configured to update at a previously set timing a coefficient which is used in a normalizing processing in which the signal of the first Hall element and the signal of the second Hall element are normalized.

10. The motor according to claim 1, wherein
the reference data comprises a plurality of peak values and a plurality of bottom values, and
the position detection section is configured to obtain a current position of the rotor based on a magnitude relationship and an arrangement order of the plurality of the peak values and the plurality of the bottom values.

11. The motor according to claim 1, wherein a magnetized pattern of the drive magnet is formed in a sine wave shape.

12. The motor according to claim 1, wherein
the position detection section is configured to obtain all combinations of first candidates which are candidates of the rotation position corresponding to the first signal and second candidates which are candidates of the rotation position corresponding to the second signal, the first candidates and the second candidates being adjacent candidates of the rotation position to each other, and
the position detection section is configured to calculate a difference of the first candidate and the second candidate in each of the obtained combinations and obtains the rotation position of the detection target from the combination that a value of the difference is the smallest.

13. The motor according to claim 12, wherein
a number of magnetic poles of the drive magnet is four or more,
the reference data comprises:
first reference data which are prepared by associating the rotation position of the rotor with the signal of the first Hall element obtained at the rotation position; and
second reference data which are prepared by associating the rotation position of the rotor with the signal of the second Hall element obtained at the rotation position, each of the first reference data and the second reference data comprises:
a plurality of peak values and a plurality of bottom values; and
a plurality of inclined parts which are located between the peak values and the bottom values adjacent to each other,
the position detection section is configured to obtain the first candidates one by one from the inclined part including the rotation position of the rotor detected latest and from the two adjacent inclined parts located on both sides by referring to the first reference data,
the position detection section is configured to obtain the second candidates one by one from the inclined part including the rotation position of the rotor detected latest and from the two adjacent inclined parts located on both sides by referring to the second reference data, and
the position detection section is configured to obtain the rotation position of the detection target from the combination that a difference between the first candidate and the second candidate is the smallest among the combinations of the three first candidates having been obtained and the three second candidates having been obtained.

14. The motor according to claim 13, wherein
the position detection section is configured to obtain the combinations where one or both of the first candidate and the second candidate are located in the inclined parts including the rotation position of the rotor detected latest among the combinations of the three first candidates and the three second candidates, and
the position detection section is configured to obtain the rotation position of the detection target from the combination that a difference between the first candidate and the second candidate is the smallest among the combinations having been obtained.

15. The motor according to claim 12, wherein the position detection section is configured to set the rotation position obtained from the combination that the difference between the first candidate and the second candidate is the smallest to a home position of the rotation position of the rotor.

16. The motor according to claim 15, wherein the storage section is configured to store the rotation position obtained from the combination that the difference between the first candidate and the second candidate is the second smallest as a correction candidate position for correcting the home position.

17. The motor according to claim 12, wherein the position detection section is configured to update at a previously set timing a coefficient which is used in a normalizing processing in which the signal of the first Hall element and the signal of the second Hall element are normalized.

18. The motor according to claim 8, wherein
the position detection section is configured to obtain all combinations of first candidates which are candidates of the rotation position corresponding to the first signal and second candidates which are candidates of the rotation position corresponding to the second signal from the reference data, and
the position detection section is configured to calculate a difference of the first candidate and the second candidate in each of the obtained combinations and obtains the rotation position of the detection target from the combination that a value of the difference is the smallest.

19. The motor according to claim 8, wherein
the position detection section is configured to obtain all combinations of first candidates which are candidates of the rotation position corresponding to the first signal and second candidates which are candidates of the rotation position corresponding to the second signal, the first candidates and the second candidates being adjacent candidates of the rotation position to each other, and
the position detection section is configured to calculate a difference of the first candidate and the second candidate in each of the obtained combinations and obtains the rotation position of the detection target from the combination that a value of the difference is the smallest.

20. The motor according to claim 11, wherein
the position detection section is configured to obtain all combinations of first candidates which are candidates of the rotation position corresponding to the first signal and second candidates which are candidates of the rotation position corresponding to the second signal from the reference data, and
the position detection section is configured to calculate a difference of the first candidate and the second candidate in each of the obtained combinations and obtains the rotation position of the detection target from the combination that a value of the difference is the smallest.

21. The motor according to claim 20, wherein the position detection section is configured to set the rotation position obtained from the combination that the difference between the first candidate and the second candidate is the smallest to a home position of the rotation position of the rotor.

22. The motor according to claim 11, wherein
the position detection section is configured to obtain all combinations of first candidates which are candidates of the rotation position corresponding to the first signal and second candidates which are candidates of the rotation position corresponding to the second signal, the first candidates and the second candidates being adjacent candidates of the rotation position to each other, and
the position detection section is configured to calculate a difference of the first candidate and the second candidate in each of the obtained combinations and obtains the rotation position of the detection target from the combination that a value of the difference is the smallest.

23. The motor according to claim 22, wherein the position detection section is configured to set the rotation position obtained from the combination that the difference between the first candidate and the second candidate is the smallest to a home position of the rotation position of the rotor.
